(19) United States
(12) Patent Application Publication
(10) Pub. No.: US 2014/0215153 A1
(43) Pub. Date: Jul. 31, 2014

(54) STORAGE SYSTEM, DISK ARRAY APPARATUS AND CONTROL METHOD FOR STORAGE SYSTEM

(71) Applicant: NEC CORPORATION, Tokyo (JP)

(72) Inventor: MITSUHIRO KAGA, Tokyo (JP)

(73) Assignee: NEC CORPORATION, Tokyo (JP)

(21) Appl. No.: 14/161,099

(22) Filed: Jan. 22, 2014

(30) Foreign Application Priority Data
Jan. 31, 2013 (JP) 2013-017355

(51) Int. Cl. G06F 3/06

(52) U.S. Cl. CPC G06F 3/0689; G06F 3/0604; G06F 3/0646
USPC 711/114

(57) ABSTRACT

Provided is a storage system which is configured such that, when high-load processing is carried out by each of at least one of the storage nodes, an access is made in a method in which the access is made asynchronously with other nodes, and a completion of the access is not waited for, and in each of the at least one storage node other than the at least one storage node carrying out the high-load processing, an access is made in a method in which the access is made synchronously with any other one of the at least one storage node other than the storage node carrying out the high-load processing, and a completion of the access is waited for.

This application is based upon and claims the benefit of priority from Japanese Patent Application No. 2013-017355, filed on Jan. 31, 2013, the disclosure of which is incorporated herein in its entirety by reference.

### 1. TECHNICAL FIELD

The present invention relates to a storage system including a plurality of nodes in which data is stored in a distributed way, a disk array apparatus and a control method for controlling a storage system.

### 2. BACKGROUND ART

In a storage apparatus, such as a distributed storage apparatus, it is necessary to carry out maintenance processing on a regular basis, such as daily or weekly. In general, such maintenance processing, sometimes, causes a situation in which a processing load imposed on a central processing unit (CPU), a disk and other devices becomes large to a non-negligible degree. As a result, during execution of such maintenance processing, input and output processing, which is a function to be essentially provided by the storage apparatus, is significantly influenced by the maintenance processing.

For example, in a general storage apparatus of duplication exclusion type, it is necessary to carry out area release processing periodically. In this periodic area opening processing, an area release is performed in each of all nodes, and the area release and a resource allocation for writing or reading processing are dynamically performed. Nevertheless, it is difficult to predict in advance when a request for writing or reading is received, and thus, the resource allocation is not in time at around the beginning or end of the writing or the reading processing, so that this defect causes a performance degradation and a non-efficiency of the area release.

For this reason, as a measure for this problem, the maintenance processing is performed during a period of time when a processing load on essential processing is relatively light. Nevertheless, when a storage apparatus still needs to operate while the maintenance processing is performed, as a result, the storage apparatus is damaged by a significant performance degradation.

As a measure for the occurrence of such a situation, there has been a technology for performing control so as to cause a storage apparatus to operate to a degree that does not affect essential functions by restricting resources, such as a CPU, and a high priority from being given to maintenance processing or the like. Further, there has been an ingenuity which allows a storage apparatus to make an adjustment with respect to resources and a high priority given to maintenance processing in response to a state of a processing load on essential functions so that execution of the maintenance processing can be restricted to a more degree while the processing load on the essential functions is high, and the maintenance processing can be promptly executed within an allowable range of the resources while the processing load on the essential functions is low.

In general, when writing or reading processing based on a request from an upper-layer application and high-load processing included in maintenance processing which is periodically performed on nodes are simultaneously exist, in order to maintain the processing performance of the writing or reading processing, the following method is carried out (FIGS. 10A and 10B).

First, as shown in FIG. 10A, when there exists no writing or reading processing, high-load processing is simultaneously performed in each of all nodes. In this case, a resource allocation (a bandwidth of a disk input/output (I/O)) to the high-load processing can be made, for example, 100% in each of all the nodes. Further, as shown in FIG. 10B, when there exists any writing or reading processing, a resource allocation to each of the writing or reading processing and the high-load processing is dynamically made. For example, the resource allocation can be made such that 75% of resources is allocated to the writing or reading processing, and 25% of the resources is allocated to the high-load processing.

In this method, however, there exist two problems described below (FIG. 11).

A first problem is that it is difficult to predict a timing point at which writing or reading processing based on a request from an upper-layer application begins, and thus, a resource allocation is not in time at a beginning portion of the writing or reading processing and the beginning portion is overlapped with high-load processing included in maintenance processing, so that a performance degradation occurs. Thus, sometimes, a given performance requirement cannot be satisfied at the beginning portion of the writing or reading processing. Such a performance degradation occurs during a period, such as a period “a” shown in FIG. 11, when the high-load processing is overlapped with the writing or reading processing in a case where the writing or reading processing is caused to begin during execution of the high-load processing, or the like.

A second problem is that, when the high-load processing resumes subsequent to the completion of the writing or reading processing based on a request from an upper-layer application, a period when no resources are used exists between a period when the high-load processing is performed and a period when the writing or reading processing is performed, and thus, intermittent writing or reading processing increases the period when no resources are used. Such a period when no resources are used is illustrated as a period “b” of FIG. 11. The period “b” indicates a period when any resources are not used in both the high-load processing and the writing or reading processing.

Further, in Japanese Unexamined Patent Application Publication No. 2011-13908, there is disclosed a redundant data management method to which particular RAID 5 is applied (“RAID” being an abbreviation of redundant arrays of inexpensive disks or redundant arrays of independent disks). In the redundant data management method disclosed in Japanese Unexamined Patent Application Publication No. 2011-13908, redundant data is moved to low-performance physical disks during execution of writing, and the redundant data is moved to high-performance physical disks during execution of reading. In this way, as a result, during execution of writing, high-performance disks are caused to carry out writing of redundant data for which the frequency of accesses increases during the execution of writing, and during execution of reading, low-performance disks are caused to carry out reading of the redundant data which is unnecessary to be referred to during the execution of reading. In Japanese Unexamined Patent Application Publication No. 2011-13908, dynamic performance is grasped through, not only static performance of the physical disk, but also a parameter which is called performance dissimilarity, and the redundant data is arranged such that, in high dynamic-performance physical disks, the number of writing accesses increases. In such a way as described above, it is possible to prevent a performance degradation of logical disks by reducing the frequency of accesses to low reading performance disks.

As described above, a time lag relative to a load variation arises merely by making a dynamic adjustment with respect to resources and a high priority given to maintenance processing. For example, in the case of a sudden occurrence of I/O processing or the like, some time portions, such as a time portion necessary for a collection of statistical information until coming to recognition of a high-load state, and a time portion necessary for an actual convergence of resources and the like for the I/O processing from the beginning of movement of the maintenance processing to a lower priority state, result in the time lag. That is, there arises a problem that such a time lag relative to a load variation in the dynamic adjustment with respect to resources and a high priority given to the maintenance processing is observed as a period of time during which processing performance is degraded to a non-negligible degree in a system constituting the storage apparatus, and brings a significant influence on operation of the system.

In the redundant data management method disclosed in Japanese Unexamined Patent Application Publication No. 2011-13908, it follows that a parameter which is called performance dissimilarity is calculated, and redundant data is allocated to an optimal disk in accordance with performance differences which are grasped on the basis of the calculated performance dissimilarity. Further, concurrently therewith, a state of responses to reading requests or writing requests to the disks is constantly monitored. Thus, when writing or reading processing is carried out during execution of high-load processing, such as a maintenance task, there is still a possibility that an access to a disk currently performing the high-load processing is needed, so that the operation of the system is affected thereby.

An object of the present invention is to, in a distributed storage system provided with redundancy, when there exists high-load processing which is periodically carried out by all nodes, provide a technology which enables a processing performance of the system to satisfy a given performance requirement criterion with respect to writing or reading processing, and simultaneously therewith, enables realization of improvement of an efficiency of the high-load processing.

### SUMMARY

A storage system according to a first aspect of the present invention includes a plurality of storage nodes in which data is stored in a distributed way, and is configured such that, when high-load processing is carried out by each of at least one of the plurality of storage nodes, in each of the at least one storage node carrying out the high-load processing, an access is made in a method in which the access is made asynchronously with an access by each of at least one storage node other than the at least one storage node carrying out the high-load processing among the plurality of storage nodes, and a completion of the access is not waited for, and in each of the at least one storage node other than the at least one storage node carrying out the high-load processing among the plurality of storage nodes, an access is made in a method in which the access is made synchronously with any other one of the at least one storage node other than the at least one storage node carrying out the high-load processing among the plurality of storage nodes, and a completion of the access is waited for.

A disk array apparatus according to a second aspect of the present invention includes a plurality of disks in which data is stored in a distributed way, and is configured such that, when high-load processing is carried out by each of at least one of the plurality of disks, in each of the at least one disk carrying out the high-load processing, an access is made in a method in which the access is made asynchronously with an access by each of at least one disk other than the at least one disk carrying out the high-load processing among the plurality of disks, and a completion of the access is not waited for, and in each of the at least one disk other than the at least one disk carrying out the high-load processing among the plurality of disks, an access is made in a method in which the access is made synchronously with any other one of the at least one disk other than the at least one disk carrying out the high-load processing among the plurality of disks, and a completion of the access is waited for.

A control method for a storage system, according to a third aspect of the present invention, is a method for controlling the storage system including a plurality of storage nodes in which data is stored in a distributed way. When high-load processing is performed in each of at least one of the plurality of storage nodes, in each of the at least one storage node carrying out the high-load processing, the control method includes making an access in a method in which the access is made asynchronously with an access by each of at least one storage node other than the at least one storage node carrying out the high-load processing among the plurality of storage nodes, and a completion of the access is not waited for, and in each of the at least one storage node other than the at least one storage node carrying out the high-load processing among the plurality of storage nodes, the control method includes making an access in a method in which the access is made synchronously with any other one of the at least one storage node other than the at least one storage node carrying out the high-load processing among the plurality of storage nodes, and a completion of the access is waited for.

### BRIEF DESCRIPTION OF THE DRAWINGS

Exemplary features and advantages of the present invention will become apparent from the following detailed description when taken with the accompanying drawings in which:

FIG. 1A is a diagram for describing a concept of an exemplary embodiment according to the present invention.

FIG. 1B is a diagram for describing a concept of an exemplary embodiment according to the present invention.

FIG. 2 is a block diagram illustrating a configuration of a storage system according to an exemplary embodiment of the present invention.

FIG. 3A is diagram illustrating writing or reading operation of a storage system according to an exemplary embodiment of the present invention.

FIG. 3B is diagram illustrating writing or reading operation of a storage system according to an exemplary embodiment of the present invention.

FIG. 3C is diagram illustrating writing or reading operation of a storage system according to an exemplary embodiment of the present invention.

FIG. 3D is diagram illustrating writing or reading operation of a storage system according to an exemplary embodiment of the present invention.

FIG. 4 is a diagram illustrating writing operation in an access node of a storage system according to an exemplary embodiment of the present invention.

FIG. 5 is a diagram illustrating writing operation in a storage node of a storage system according to an exemplary embodiment of the present invention.

FIG. 6 is a schematic diagram illustrating a writing method in a storage system according to an exemplary embodiment of the present invention.

FIG. 7 is a flowchart illustrating data verification after the completion of writing processing in a storage system according to an exemplary embodiment of the present invention.

FIG. 8 is a diagram illustrating reading operation in a storage system according to an exemplary embodiment of the present invention.

FIG. 9A is a block diagram illustrating a configuration of a disk array system according to a modification example of an exemplary embodiment of the present invention.

FIG. 9B is a block diagram illustrating a configuration of a disk array system according to a modification example of an exemplary embodiment of the present invention.

FIG. 9C is a block diagram illustrating a configuration of a disk array system according to a modification example of an exemplary embodiment of the present invention.

FIG. 9D is a block diagram illustrating a configuration of a disk array system according to a modification example of an exemplary embodiment of the present invention.

FIG. 10A is a diagram for describing a relation between writing or reading processing and high-load processing in a related technology.

FIG. 10B is a diagram for describing a relation between writing or reading processing and high-load processing in a related technology.

FIG. 11 is a diagram for describing a problem of a related technology.

### EXEMPLARY EMBODIMENT

Hereinafter, an exemplary embodiment for practicing the present invention will be described with reference to the drawings. It is to be noted that an exemplary embodiment described below include various technically preferable limitations to carry out the present invention, but the scope of the invention is not limited to the exemplary embodiment described below.

### Exemplary Embodiment

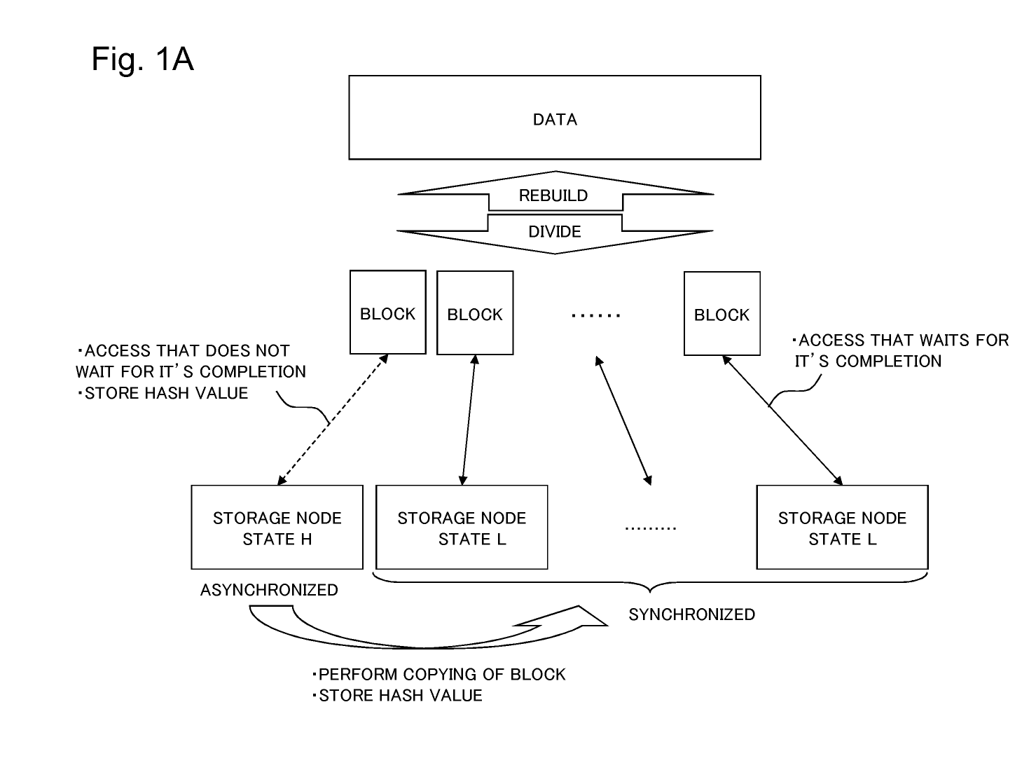

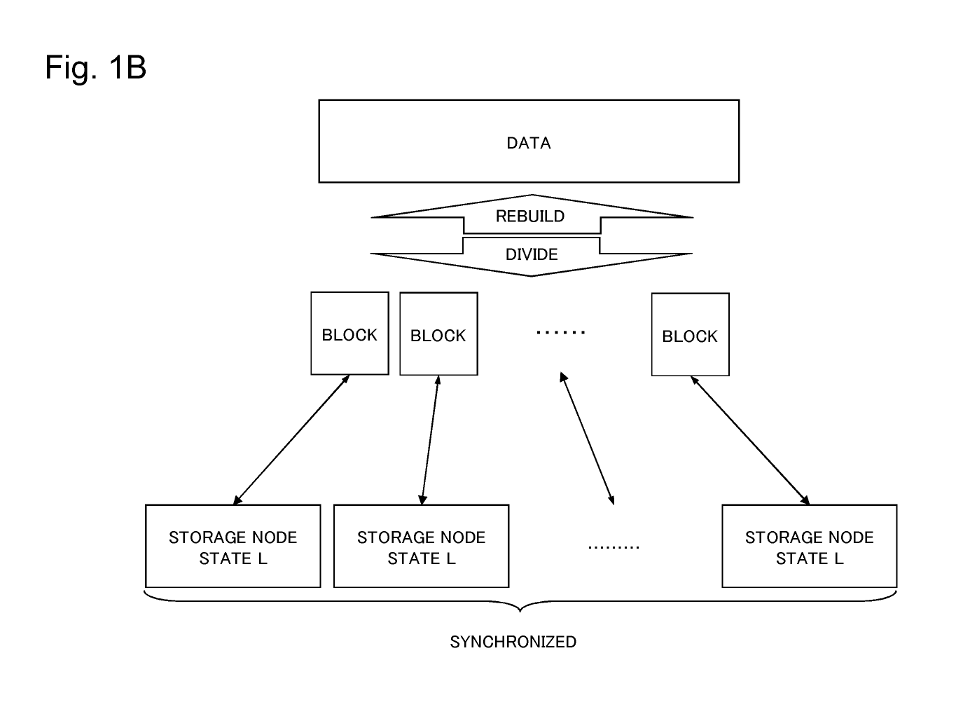

First, a concept of an exemplary embodiment according to the present invention will be described with reference to FIGS. 1A and 1B. In each of FIGS. 1A and 1B, there is illustrated a condition in which data is divided into a plurality of blocks, and each of the plurality of blocks is allocated to a corresponding one of storage nodes. In addition, in the case where data does not need to be divided into blocks, in FIGS. 1A and 1B, processing for dividing data into blocks may be omitted, and further, in a portion indicating “block”, the “block” may be replaced with “data”. In the following description of this specification, unless any particular notice is given, a block means data that has been configured into a block of data, and the block itself has a data structure.

This exemplary embodiment according to the present invention relates to a storage system in which data is stored in a plurality of storage nodes in a distributed way. In addition, in this exemplary embodiment according to the present invention, configuration is made such that an access method for writing or reading processing is different between a storage node currently performing high-load processing, such as maintenance processing, and each of the other storage nodes. Further, in FIGS. 1A and 1B, with respect to line segments each having arrows at its opposite ends, and connecting between a block and a storage node, a line segment denoted by a full line indicates “writing or reading processing that waits for its completion”, and a line segment denoted by a dashed line indicates “writing or reading processing that does not wait for its completion”.

First, a case where high-load processing is performed will be described with reference to FIG. 1A.

In a storage node currently performing high-load processing, the “writing processing that does not wait for its completion”, which is denoted by the dashed line in FIG. 1A, is carried out asynchronously with processing by each of the other storage nodes. In contrast, in each of the other storage nodes, the “writing processing that waits for its completion”, which is denoted by the full line in FIG. 1A, is carried out synchronously with processing by any other one of the other storage nodes.

Further, the storage node currently performing high-load processing, shown in FIG. 1A, stores therein a block together with its hash value. Moreover, one of the other storage nodes shown in FIG. 1A performs copying the block having been stored in the storage node currently performing high-load processing to obtain a replica thereof, and stores therein the replica together with the hash value.

When processing for reading out data is performed, data is rebuilt on the basis of blocks having been read out from the other storage nodes without waiting for reading out of data from the storage node currently performing high-load processing. That is, in a storage node performing high-load processing, the “reading processing that does not wait for its completion”, which is denoted by the dashed line in FIG. 1A, is carried out asynchronously with processing by each of the other storage nodes. Further, in each of the other storage nodes, the “reading processing that waits for its completion”, which is denoted by the full line in FIG. 1A, is carried out synchronously with processing by any other one of the other storage nodes.

Next, a case where the high-load processing is not performed will be described with reference to FIG. 1B.

In the case where the high-load processing is not performed, in each of all storage nodes, the “writing or reading processing that waits for its completion”, which is denoted by the full line in FIG. 1B, is carried out synchronously with processing by any other one of the all storage nodes.

As described above, in this exemplary embodiment according to the present invention, in the case where high-load processing is performed, as shown in FIG. 1A, in a storage node performing the high-load processing, accesses in accordance with a method in which a completion of each of the accesses is not waited for are made asynchronously with accesses by any one of the other nodes; while, in each of the other storage nodes, accesses in accordance with a method in which a completion of each of the accesses is waited for are made synchronously with any other one of the other nodes. Further, in the case where high-load processing is not performed, as shown in FIG. 1B, in each of all storage nodes, accesses in accordance with a method in which a completion of each of the accesses is waited for are made synchronously with any other one of the all storage nodes.

The above is description of this exemplary embodiment according to the present invention, shown in FIG. 1. In addition, this exemplary embodiment according to the present invention illustrated in FIGS. 1A and 1B is just an example, and the scope of the present invention is not limited to this exemplary embodiment.

Hereinafter, this exemplary embodiment according to the present invention will be described in detail by illustrating a specific configuration of the storage system.

### (Storage System)

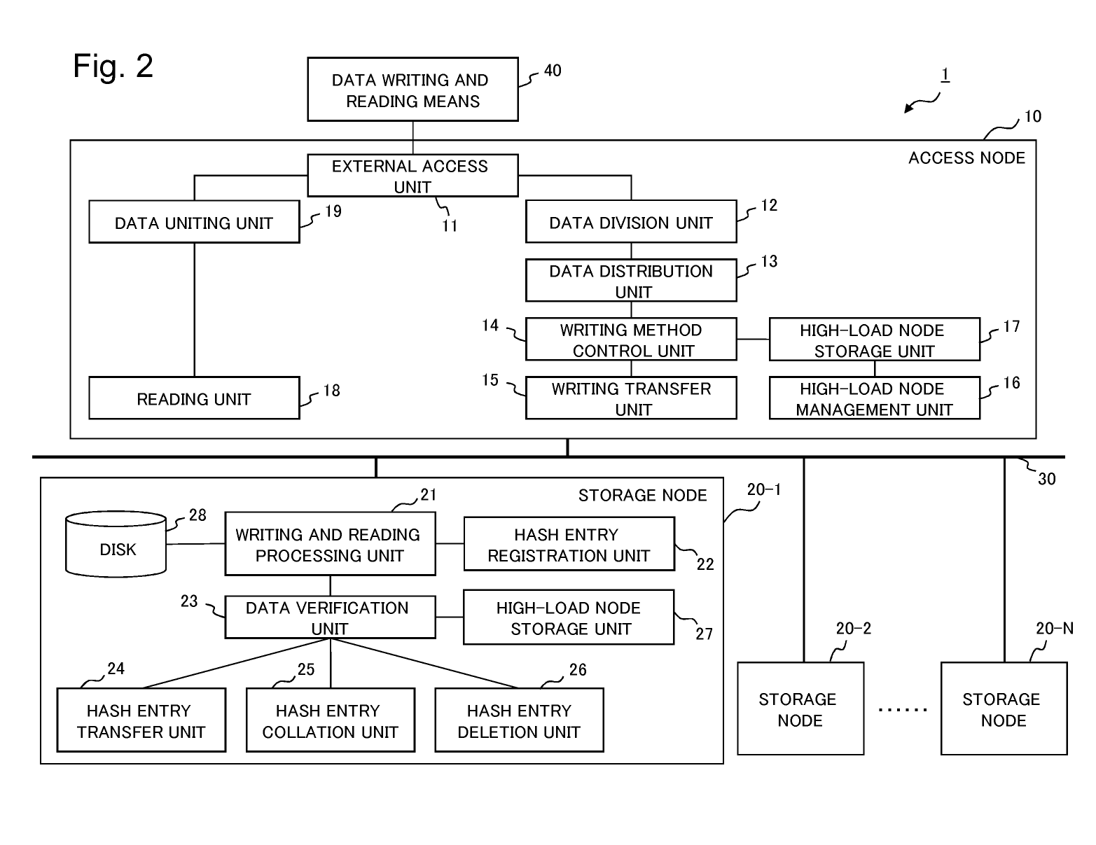

FIG. 2 is a block diagram illustrating a configuration of a storage system 1 according to this exemplary embodiment of the present invention.

The storage system 1 according to this exemplary embodiment of the present invention includes one access node 10 and N storage nodes 20 (from 20-1 to 20-N). In addition, it is supposed that N is any natural number no smaller than 2. Further, a data writing and reading means 40 may not be included in the configuration of the storage system 1 according to this exemplary embodiment of the present invention, and is handled as a component which is added as needed.

An access node 10 divides data acquired from an outside object into blocks; carries out writing and reading of the blocks into/from a plurality of storage node 20; and concurrently therewith, manages a storage node 20 currently performing high-load processing among the plurality of nodes 20. The access node 10 and each of the N storage nodes 20 are mutually connected so as to be data transferable with each other via a bus 30. In addition, the bus 30 may be a common-use network, such as the Internet or a general telephone link, or a dedicated network which is built as an intranet.

### (Access Node)

The access node 10 includes an external access unit 11, a data division unit 12, a data distribution unit 13, a writing method control unit 14, a writing transfer unit 15, a high-load management unit 16, a high-load node storage unit 17, a reading unit 18 and a data uniting unit 19.

The external access unit 11, which corresponds to an external access means, deals with a request for reading data and a request for writing data from an external object; transfers data to an inside portion, that is, a lower-layer portion, of the access node 10; and sends back data to the external object.

In the storage system 1, shown in FIG. 2, according to this exemplary embodiment of the present invention, configuration is made such that accesses to the external access unit 11 can be made via the data writing and reading means 40. The data writing and reading means 40 can be constituted of programs, such as pieces of software executing writing and reading of data. In addition, the data writing and reading means 40 may not be necessarily included in the storage system 1 according to this exemplary embodiment of the present invention, and instead, the external access unit 11 may function as an interface with an external object, such as a cloud, the Internet, an upper-layer system or a user.

The data division unit 12, which corresponds to a data division means, divides writing data from the external access unit 11 into blocks consisting of a plurality of data blocks and a plurality of parity blocks. For example, the data division unit 12 divides the writing data into total twelve blocks consisting of nine data blocks and three parity blocks. In addition, a method of dividing the writing data into the data blocks and the parity blocks is not limited to the above-described method, and the writing data may be divided into blocks less than the twelve blocks or more than the twelve blocks. Further, hereinafter, when it is unnecessary to handle the data block and the parity block as mutually different ones, they will be each referred to as just a block.

The data distribution unit 13, which corresponds to a data distribution means, acquires blocks having been divided by the data division unit 12, and determines a distribution destination of each of the blocks. Any one of the storage nodes 20 is determined as the distribution destination of each of the blocks.

The writing method control unit 14, which corresponds to a writing method control means, refers to information stored in the high-load node storage unit 17, which will be described below, and determines a writing method for each of blocks having been acquired from the data distribution unit 13 in accordance with a piece of information indicating the presence or absence of a high-load node included in the information. In addition, the high-load node means a storage node 20 whose processing load becomes high because of its execution of maintenance processing or the like. Further, specific writing methods will be described in detail below.

The writing transfer unit 15, which corresponds to a writing transfer means, transfers each of blocks having been received via the writing method control unit 14 to a corresponding one of the storage nodes 20. In addition, the writing transfer unit 15 is connected to a writing and reading processing unit 21 included in each of the storage nodes 20 so as to be data transferable with the writing and reading processing unit 21.

The high-load management unit 16, which is a high-load node management means, is connected to the high-load node storage unit 17, and manages a storage node 20 that performs high-load processing. The high-load management unit 16 makes a determination or a change of order in accordance with which a node that performs high-load processing is allocated. In addition, the high-load management unit 16 is also connected to a high-load node storage unit 27 included in each of the storage node 20 so as to be data transferable with the high-load node storage unit 27.

In this exemplary embodiment according to the present invention, the high-load processing is different from processing for writing or reading of data, and means heavy-load processing, such as maintenance processing. In addition, the storage node 20 that performs high-load processing is not necessarily limited to just one storage node 20, and in the case where the storage system 1 includes a large number of storage nodes 20, some storage nodes 20 among them may be each allowed to perform high-load processing. Further, the high-load processing means processing including a process, such as a network connection process, a virus scanning process, a software uploading and downloading process or a computer background process, and the high-load processing is not necessarily limited to the maintenance processing.

The high-load node storage unit 17, which corresponds to a first high-load node storage means, stores therein a storage node 20 currently performing high-load processing. The information which is related to the storage node 20 currently performing high-load processing and is stored in the high-load node storage unit 17 is referred to by the writing method control unit 14.

The reading unit 18, which corresponds to a reading means, requests each of the storage nodes 20 to perform reading processing, and collects each block constituting data from the each of the storage nodes 20. The reading unit 18 is connected to the writing and reading processing unit 21 included in each of the storage nodes 20 so as to be data transferable with the writing and reading processing unit 21. Further, the reading unit 18 sends the block having been collected from each of the storage nodes 20 to the data uniting unit 19.

The data uniting unit 19, which corresponds to a data uniting means, rebuilds data by uniting the block having been acquired from each of the storage nodes 20 by the reading unit 18, and transfers the rebuilt data to the external access unit 11. The data having been transferred to the external access unit 11 is read out to an external object by the data writing and reading means 40.

### (Storage Node)

The storage node 20 includes a writing and reading processing unit 21, a hash entry registration unit 22, a data verification unit 23, a hash entry transfer unit 24, a hash entry collation unit 25, a hash entry deletion unit 26, a high-load node storage unit 27 and a disk 28.

FIG. 2 illustrates a condition in which each of the N storage nodes 20 (20-1, 20-2, . . . and 20-N) is connected to the access node 10 and the other ones of the storage nodes 20 via a bus 30. Further, each of the N storage nodes 20 (20-1, 20-2, . . . and 20-N) includes the same components as those of any other one of the storage nodes 20.

The writing and reading processing unit 21, which corresponds to a writing and reading processing means, makes an access to the disk 28 (that is, performs processing for writing data into the disk 28 or processing for reading data from the disk 28) in response to a writing request or a reading request having been sent from the access node 10. In addition, the writing and reading processing unit 21 is connected to the reading unit 18 and the writing transfer unit 15, which are included in the access node 10, so as to be data transferable with the reading unit 18 and the writing transfer unit 15.

The hash entry registration unit 22, which corresponds to a hash entry registration means, is connected to the writing and reading processing unit 21; creates a hash entry for a writing block; and registers the created hash entry into a hash table. The hash table stores therein a plurality of hash entries each being a pair of a key and a hash value, and has a data structure which enables prompt reference of a hash value associated with a key. In addition, in this exemplary embodiment, the key corresponds to a node number, and the hash value corresponds to data which has been configured into a block of data. The hash table can be stored in, for example, the disk 28, or may be stored in a different storage unit (not illustrated) as needed.

The data verification unit 23, which corresponds to a data verification means, is connected to the writing and reading processing unit 21, and causes the entry transfer unit 24, the hash entry collation unit 25 and the hash entry deletion unit 26, each being a lower-layer portion of the writing and reading processing unit 21, to operate in order to verify the accordance of data included in a block after the completion of writing of the block.

The hash entry transfer unit 24, which corresponds to a hash entry transfer means, transfers the hash entry having been registered by the hash entry registration unit 22 to a storage node 20 being the high-load node.

The hash entry collation unit 25, which corresponds to a hash entry collation means, and which is included in a storage node 20 being the high-load node, collates each of hash entries owned by this storage node 20 itself with a corresponding one of hash entries having been transferred from the hash entry transfer units 24 of the other storage nodes 20, and thereby verifies accordance with respect to the hash entries.

The hash entry deletion unit 26, which corresponds to a hash entry deletion means, deletes the hash entries for which the accordance has been verified by the hash entry collation unit 25.

The high-load node storage unit 27, which corresponds to a second high-load node storage means, stores therein a node currently performing high-load processing. In addition, the high-load node storage unit 27 is connected to the high-load management unit 16 of the access node 10 so as to be data transferable with the high-load management unit 16 via the bus 30.

The disk 28, which corresponds to a block storage means in appended claims, is a disk area in which blocks targeted for writing and reading are stored. In addition, the disk 28 may store therein other data besides the blocks.

The above is the configuration of the storage system 1 according to this exemplary embodiment of the present invention. It is to be noted, nevertheless, that the aforementioned configuration is just an example, and configurations resulting from making various modifications and/or additions on the aforementioned configuration are also included in the scope of the present invention.

### (Operation)

Here, a process flow of operation of the storage system 1 according to this exemplary embodiment of the present invention will be described.

### (Operation of Access Node)

First, operation with respect to management of a storage node 20 that performs high-load processing will be described without using a flowchart.

The high-load management unit 16 included in the access node 10 shown in FIG. 2 determines one of the storage nodes 20 as a storage node that performs high-load processing, and causes the relevant storage node 20 to carry out the high-load processing. Further, the high-load management unit 16 causes the high-load node storage unit 17 included in the access node 10 and the high-load node storage unit 27 included in each of the storage nodes 20 to store therein the relevant storage node 20 currently performing high-load processing. At this time, the relevant storage node 20 currently performing high-load processing is stored as a storage node 20 in state H, and each of the other storage nodes 20 is stored as a storage node 20 in state L.

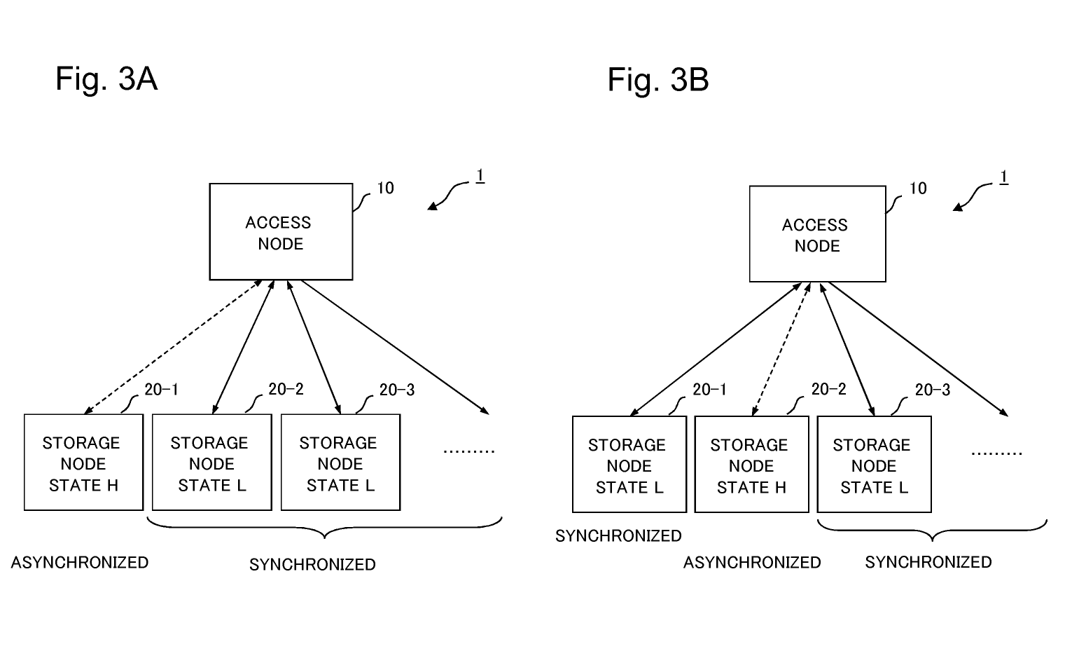

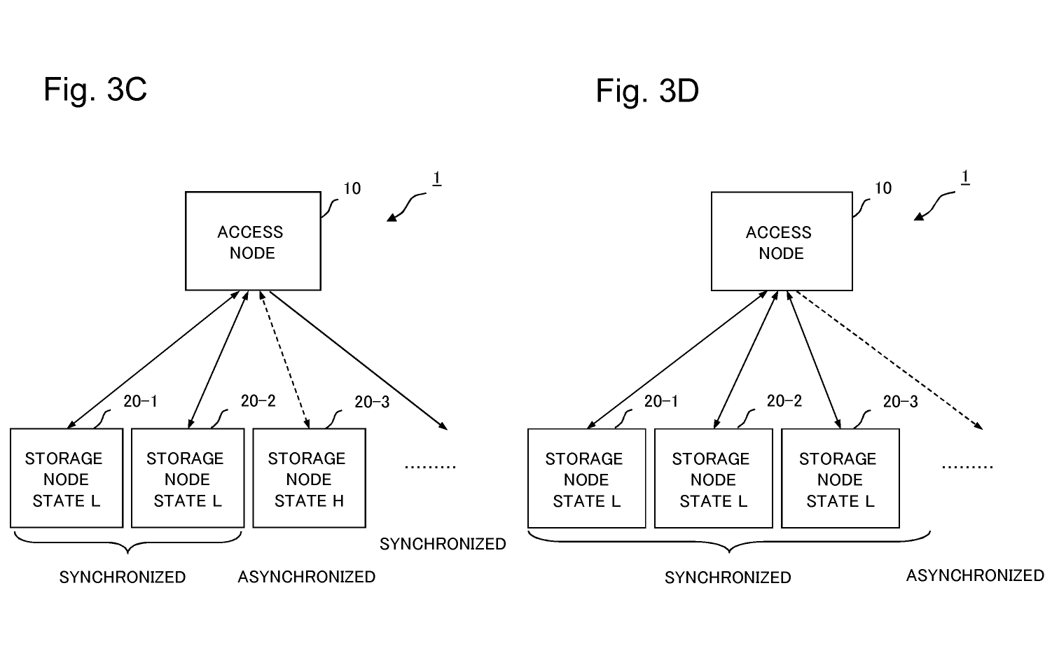

In each of FIGS. 3A to 3D, an example of operation of writing or reading blocks is illustrated. Further, in FIGS. 3A to 3D, there is illustrated a condition in which a storage node 20 in state H makes a transition in order as follows: FIG. 3A, FIG. 3B, FIG. 3C, and FIG. 3D. In each of FIGS. 3A to 3D, with respect to line segments each having arrows at its opposite ends, and connecting between the access node 10 and one of the storage nodes 20, a line segment denoted by a full line indicates “writing or reading processing that waits for its completion”, and a line segment denoted by a dashed line indicates “writing or reading processing that does not wait for its completion”.

For example, in FIGS. 3A to 3D, since, in the state shown in FIG. 3A, a storage node 20-1 is carrying out high-load processing, the storage node 20-1 is stored as a storage node 20 in state H. When the high-load processing in the node in state H (i.e., the storage node 20-1) has been completed, the high-load management unit 16 causes a next storage node 20 (a storage node 20-2) to carry out high-load processing and updates the state stored in the high-load node storage unit 17 and the state stored in the high-load node storage unit 27 of each of the storage units 20. That is, as shown in FIG. 3B, the state of the storage 20-2 is changed into state H, and simultaneously therewith, the state of the storage 20-1 is changed into state L.

Similarly, as shown in FIG. 3C, when the high-load processing in the storage node 20-2 has been completed, a storage node 20-3 is moved to be carrying out high-load processing. Further, when the high-load processing in the storage node 20-3 has been completed, a state of a certain storage node 20 other than the above storage nodes 20 having been allocated as a storage node that carries out high-load processing is changed into state H, and similarly, high-load processing is carried out by the certain storage node 20. Such a series of operation is repeated until the completion of high-load processing in each of all the storage nodes 20.

It is to be noted, nevertheless, the transition of the storage node 20 in state H is not limited to the order illustrated in FIGS. 3A to 3D. For example, when high-load processing has been completed in a certain storage node 20, a storage node 20 whose node number is consecutive to that of the certain storage node 20 may be allocated as a next storage node 20 in state H. Further, the storage node 20 in state H may be allocated in accordance with such a specific rule that prescribes that its node number is to be every other node number or every second node number. Moreover, the storage node 20 in state H may be allocated in order in accordance with the storage capacity, an available storage capacity, the performance, or the like, of the disk 28.

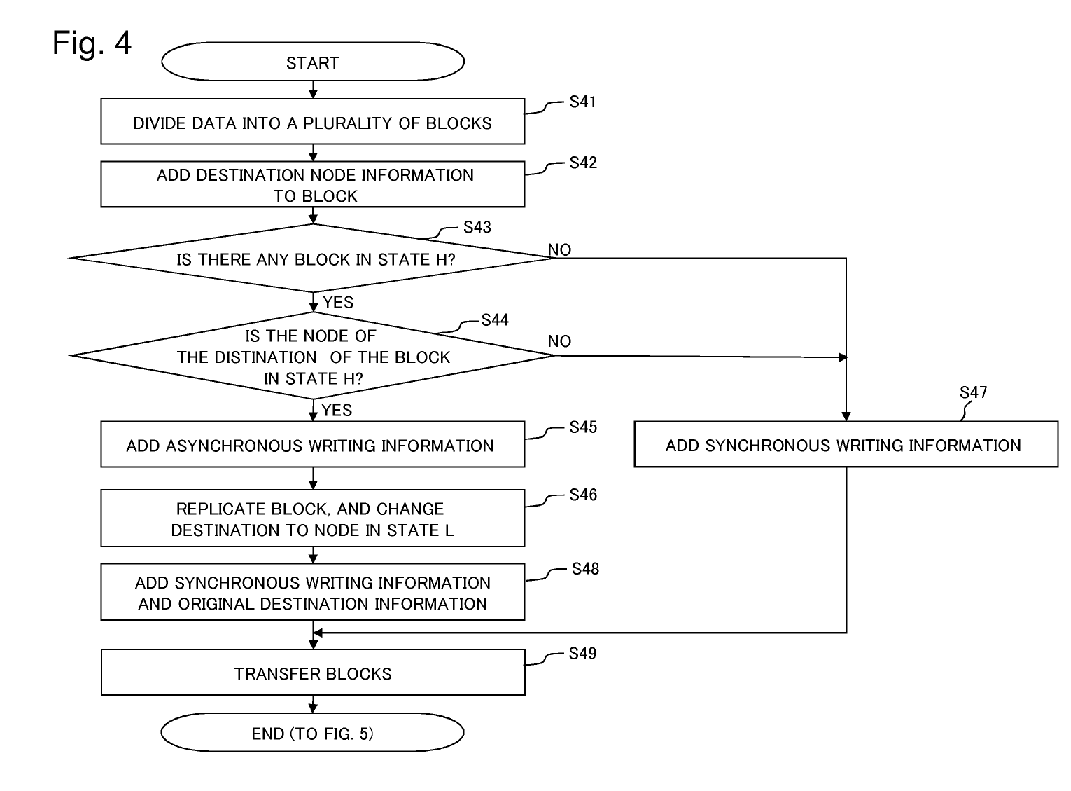

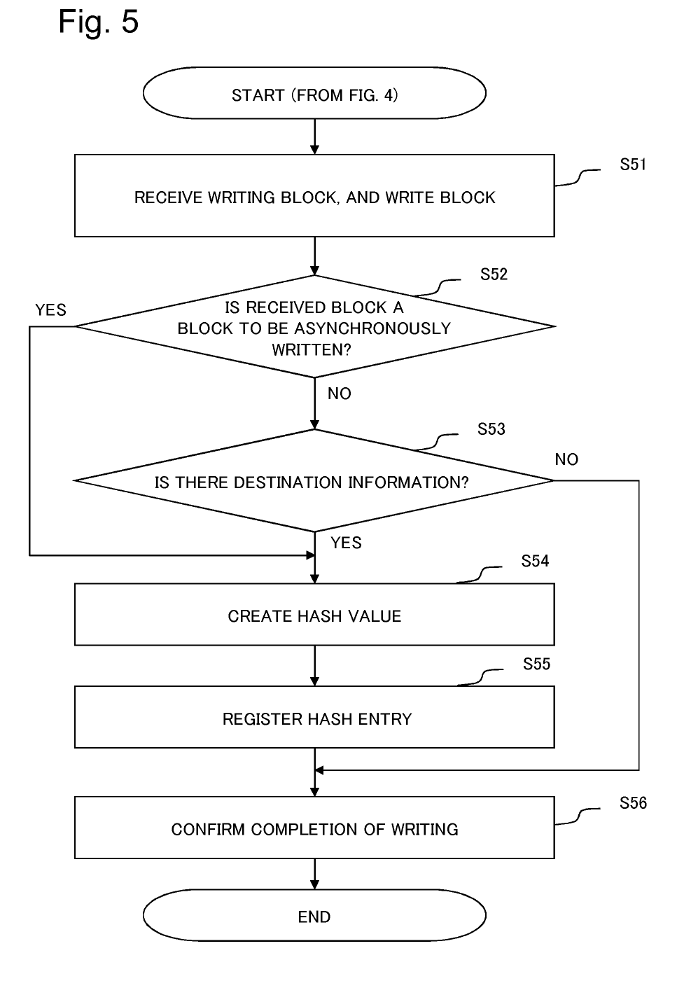

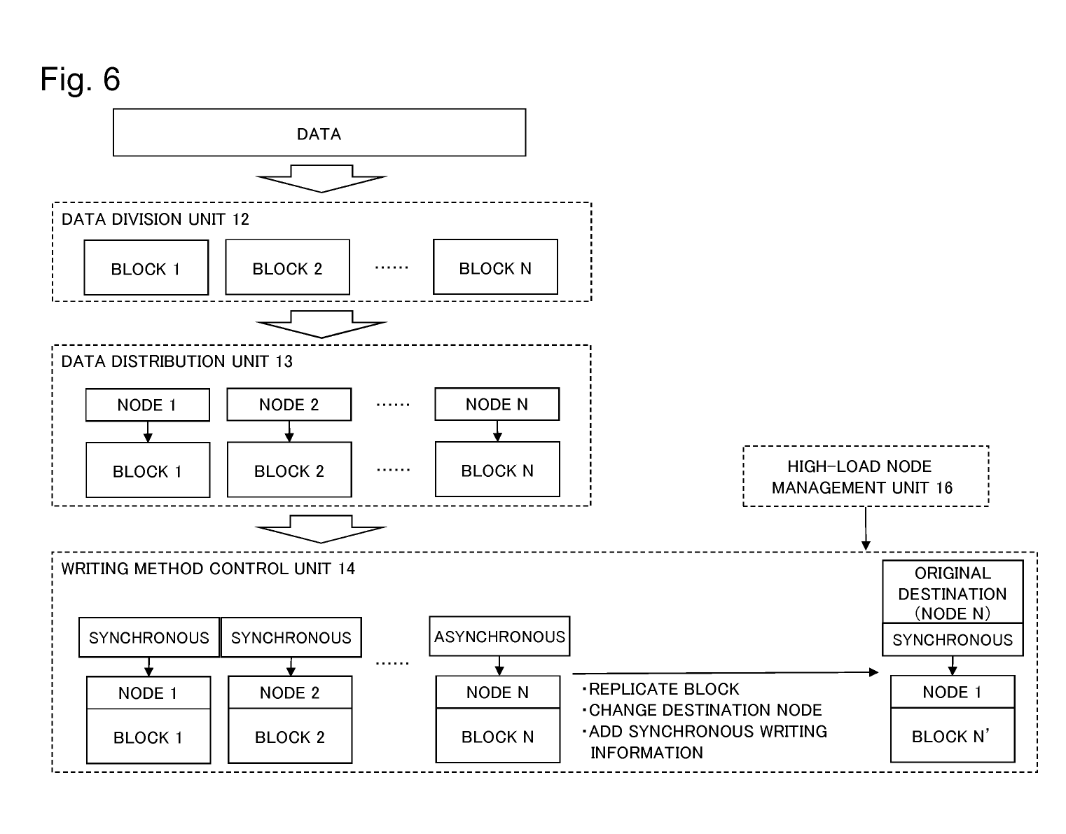

Here, operation when processing for writing data is performed will be described with reference to a flowchart shown in FIGS. 4 and 5 and a schematic diagram shown in FIG. 6. In addition, FIG. 4 relates to operation of the access node 10, and FIG. 5 relates to operation of the storage node 20.

First, in FIG. 4, the data division unit 12 divides writing data having been received by the external access unit 11 into a plurality of blocks (Step S41). This operation is indicated by a condition in which the writing data is divided into a block 1, a block 2, . . . and a block N in the data division unit 12 shown in FIG. 6. In addition, when the writing data is stored into a storage node 20 without being divided into blocks, the writing data is regarded as a block, and the process flow proceeds to next step S42.

Next, the data distribution unit 13 gives a piece of destination node information to each of the plurality of divided blocks (Step S42). This operation is indicated by a condition in which “node 1”, “node 2”, . . . and “node N” are added to the block 1, the block 2, . . . and the block N, respectively, in the data distribution unit 13 shown in FIG. 6.

The writing method control unit 14 refers to information stored in the high-load node storage unit 17 and inspects the presence or absence of a storage node 20 in state H (Step S43).

Here, in the case where there exists no storage node 20 in state H (“No” in Step S43), the writing method control unit 14 adds a piece of synchronous writing information to each of the blocks (Step S47).

Further, the writing transfer unit 15 transfers each of the blocks, to which the piece of synchronous writing information is added, to one of the storage nodes 20 (Step S49).

After Step S49, the process flow proceeds to Step S51 of FIG. 5.

Here, a case where there exists a storage node 20 in state H (“Yes” in Step S43), the writing method control unit 14 inspects whether the node of the destination of the block is in state H or not (Step S44). The processing in the case where there exists storage node 20 in state H will be described with reference to FIG. 6. In addition, in FIG. 6, a case where the block N is the high-load node is illustrated.

With respect to blocks (a block 1, a block 2, . . . and a block N) shown in FIG. 6, in the case where the node of the destination of the block is in state L (“No” in Step S44), a piece of synchronous writing information is added to each of blocks whose destinations are nodes 20 each in state L (Step S47), Further, in the case where the node of the destination of the block is in state H (“Yes” in Step S44), a piece of asynchronous writing information is added to a block whose destination is a storage node 20 in state H (Step S45).

The writing method control unit 14 replicates the block whose destination is the storage node 20 in state H in accordance with a designation from the high-load management unit 16. Further, the high-load management unit 16 changes the destination node of the replicated block to one of the nodes 20 in state L (Step S46). In addition, in the change of the destination node, any one of the storage nodes 20 in state L may be designated, or the designation may be made in accordance with a specific rule (which prescribes that, for example, the destination node of the replicated block is to be changed to a node adjacent to the storage node 20 in state H of interest). Further, in order to give redundancy to the replicated block, the replicated block may be allocated to, not only a single node in state L, but a plurality of nodes each in state L.

Subsequently, a piece of synchronous writing information and a piece of original destination information are added to the replicated block whose destination has been changed to a node in state L (this replicated block being denoted by a block N′ in FIG. 6) (Step S48).

Finally, the writing transfer unit 15 transfers each of the blocks of writing data to the writing and reading processing unit 21 of one of the storage nodes 20 (Step S49).

The above is description of operation of the access node 10, shown in FIG. 4. Further, the order of the operation, or the like, shown in FIG. 4 may be changed in accordance with situations.

### (Operation of Storage Node)

Next, a process flow of operation of the storage node 20 will be described with reference to FIG. 5.

First, in a flowchart shown in FIG. 5, upon reception of a block, which is a block of writing data, the writing and reading processing unit 21 of a storage node 20 writes the block into the disk 28 (Step S51).

In the case where there is a piece of asynchronous writing information added to the received block (“Yes” in Step S52), the process flow is advanced to Step S54. In the case where there is no piece of asynchronous writing information (“No” in Step S52), the presence or absence of a piece of original destination information added to the received block is verified (Step S53).

In the case where the result of the determination in Step S52 is “Yes”, and further, there is a piece of original destination information (“Yes” in Step S53), the hash entry registration unit 22 creates hash entries for the received block to which the piece of asynchronous writing information and the piece of original destination information are added (Step S54).

In the case where there is no piece of original destination information (“No” in Step S53), the hash entry registration unit 22 causes the process flow to proceed to step S56 as it is.

In the case where the result of the determination in Step S53 is “Yes”, moreover, the hash entry registration unit 22 registers the hash value into the hash table, the key of the hash value being a node number of the node currently in state H in this case (Step S55). In addition, the hash table may be stored in the disk 28 or may be stored in a not-illustrated memory unit inside the storage node 20.

A series of writing operations are determined to have been completed when all completions of the writing operations have been sent back (Step S56).

The above is description of operation of the storage node 20, shown in FIG. 5. In addition, the order of the operation, or the like, shown in FIG. 5 may be changed in accordance with situations.

### (Data Verification Processing)

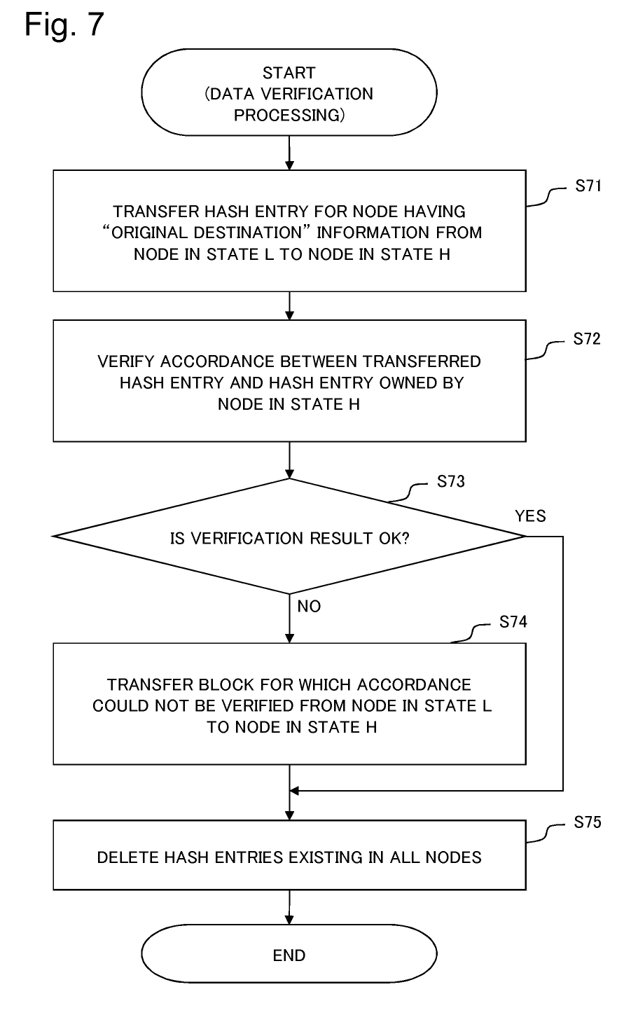

Next, a process flow of data verification processing after the completion of writing processing will be described with reference to a flowchart shown in FIG. 7.

When a series of writing operations according to the flowchart shown in FIGS. 4 and 5 have been completed, the data verification unit 23 is activated and a current state of the node itself is inspected from information stored in the high-load node storage unit 27. When the node itself is currently in H state, the hash entry transfer unit 24 is activated.

The hash entry transfer unit 24 of the storage node 20 in state H requests the hash entry transfer unit 24 of each of storage nodes 20 in state L to transfer hash entries corresponding to blocks to each of which the piece of original destination information is added among writing blocks having been stored in the each of storage nodes 20 in state L to the storage node 20 in state H. The above piece of original destination information corresponds to a node number of the storage node 20 in state H. This is processing for verifying the propriety of blocks having been stored while the relevant storage node 20 has been in state H.

In FIG. 7, the hash entry transfer unit 24 of the storage node 20 in state H collects hash entries, which have been transferred in response to the request, to the storage node 20 itself (Step S71).

The hash entry collation unit 25 of the storage node 20 in state H verifies accordance between each of the collected hash entries and a corresponding one of the hash entries owned by the storage node 20 in state H itself (Step S72).

Next, the hash entry collation unit 25 of the storage node 20 in state H determines the accordance by collating each of the collected hash entries and a corresponding one of the hash entries owned by the storage node 20 in state H itself (Step S73).

In the case where it has been determined that there is accordance (“Yes” in Step S73), in each of all the storage nodes 20, the hash entry deletion unit 26 deletes hash entries related to writing targeted for the data verification (Step S75). This is because, through the determination that there is accordance, it has been verified that the blocks having been stored by the node 20 in the H state are proper.

In the case where there is no accordance (“No” in Step S73), blocks related to hash entries for which it has been determined that there is no accordance are transferred to the storage node 20 in state H from the storage nodes 20 each in state L, and the transferred blocks are written into the disk 28 of the storage node 20 in state H (Step S74). This is because, in the case where it has been determined that there is no accordance, blocks having been stored in the storage node in state H are improper, and thus, the storage node 20 in state H needs to acquire proper blocks.

After this operation, in each of all the storage nodes 20, the hash entry deletion unit 26 deletes the hash entries related to the writing currently targeted for the data verification (Step S75).

The deletion of the hash entries in Step S75 is carried out by the hash entry deletion unit 26 included in each of the storage nodes 20. In addition, in the case where the deletion function of the hash entry deletion unit 26 included in the storage node 20 in state H is also available in each of the other storage nodes 20, the deletion of the hash entries in Step S75 may be carried out by the hash entry deletion unit 26 of the storage node 20 in state H.

The above is description of the process flow of the data verification processing after the completion of writing processing.

### (Operation of Reading Out Data)

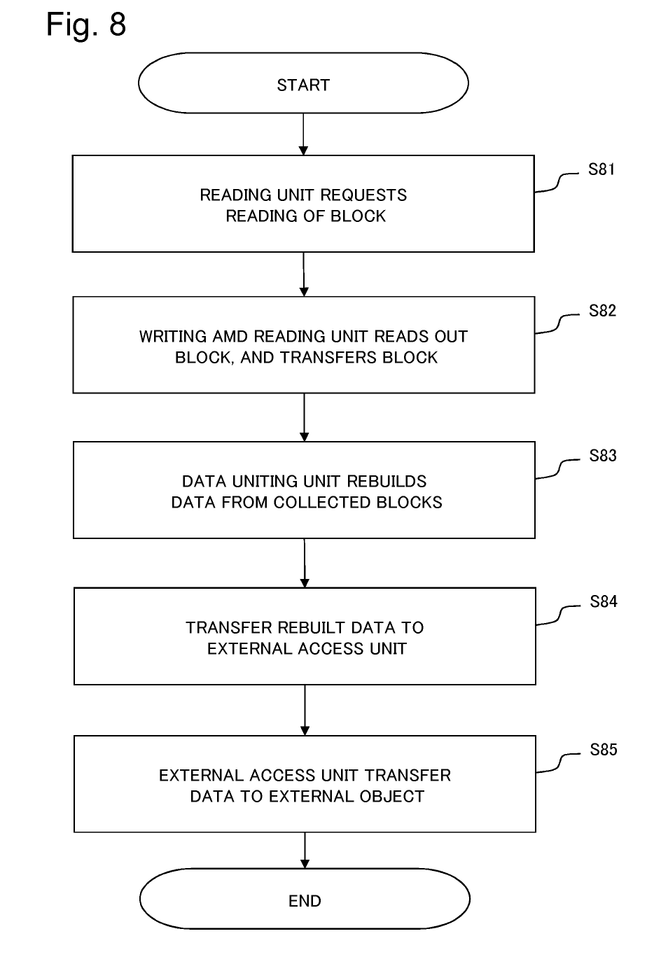

As a last description of operation, operation of reading out data will be described with reference to FIG. 8. In addition, in a process flow shown in FIG. 8, operation of the access node 10 and operation of the storage node 20 are consolidated in the same drawing.

In FIG. 8, when reading out data, the reading unit 18 of the access node 10 requests each of all the storage nodes 20 to read out blocks necessary to build data targeted for reading (Step S81).

The writing and reading processing unit 21 of each of the storage nodes 20 reads out the requested blocks from the disk 28, and begins to transfer the read-out blocks to the reading unit 18 of the access node 10 (Step S82).

The data uniting unit 19 of the access node 10 rebuilds original data at the stage when blocks having been transferred to the access node 10 are sufficient to rebuild the original data (Step S83). In addition, in the case where, before the completion of reading out blocks from a storage node 20 in state H, the rebuilding of original data becomes possible by using blocks having been read out from the other storage nodes 20, it is unnecessary to wait for the completion of reading out blocks from the storage node 20 in state H.

Rebuilt data is transferred to the external access unit 11 of the access node 10 (Step S84).

The rebuilt data is transferred to an external object by the external access unit 11 (Step S85), and then, the reading out of data is completed.

The above is description of the operation of reading out data.

The above is description of an example of operation of the storage system according to this exemplary embodiment of the present invention. It is to be noted here that the aforementioned operation is just an example of this exemplary embodiment according to the present invention, and never limits the scope of the present invention.

In the storage system according to this exemplary embodiment of the present invention, simultaneously with an activation of high-load processing in a partial node constituting the distributed storage system, a temporal degradation of response performance and the like of the partial node with respect to writing or reading processing is predicted. Further, a method for the writing or reading processing is made different between a node that performs high-load processing and each of the other nodes. Points of the description above can be summarized as follows.

(1) Nodes are classified into two types of node in advance, one being a type of node which performs only writing or reading processing (hereinafter, this type of node being referred to as a node in state L), the other one being a type of node which performs, besides the writing or reading processing, high-load processing (hereinafter, this type of node being referred to as a node in state H), and further, a method for the writing or reading processing is made different between the node in state L and the node in state H. Through making the method for writing or reading processing different between the node in state L and the node in state H as described above, the performance and redundancy of the entire storage system according to this exemplary embodiment are maintained.

(2) Among the nodes constituting the distributed storage system, one of them is allocated as the node in state H and each of the other ones of them is allocated as the node in state L. When high-load processing is completed in the node in state H, any one of the other nodes is allocated as a next node in state H, and the node which has been in H state until then is allocated as a node in L state. Subsequently, the change of the node in state H is repeated until the completion of high-load processing by each of all the nodes.

Here, the method for writing processing according to this exemplary embodiment of the present invention will be summarized below.

In order to maintain the performance and redundancy of this distributed storage system, the method for writing processing is made different between the node in state L and the node in state H as follows.

In the node in state H, processing for writing data is sequentially performed in a method of not waiting for the completion of the processing for writing data into a disk, and a hash value of the written data is stored.

In the node in state L, normal processing for writing data is sequentially performed in a method of waiting for its completion. Moreover, concurrently therewith, processing for writing distributed data, which results from distribution of data whose content is the same as that of data to be written into the node in state H, is performed in a method of waiting for its completion, and a hash value of the written data is stored.

This is because the reliability of data having been written in the node in state H is not guaranteed, and thus, is made guaranteed by performing processing for writing data, whose content is the same as that of data to be written into the node in state H, into some nodes in state L in the method of waiting for its completion.

When all writing processing based on the method of waiting for its completion has been completed, it is determined that a series of writing processing has been completed.

After the completion of the series of writing processing, the node in state H causes the some nodes in state L to transfer hash values, which have been stored in the some nodes in state L, to the node in state H.

Accordance between each of the hash values having been stored in the node in state H and a corresponding one of the hash values having been stored in the some nodes is verified.

In the case where there is accordance, the relevant hash values are deleted in all the nodes. In the case where there is no accordance, after transferring all relevant blocks of data having been written in the some nodes in state L to the node in state H, the relevant hash values are deleted in all the nodes.

The above is the summary of the writing method according to this exemplary embodiment of the present invention.

Next, the reading method according to this exemplary embodiment of the present invention will be summarized below.

The storage system according to this exemplary embodiment of the present invention is a distributed storage system provided with redundancy. Thus, it is possible to rebuild data required by a user merely by reading out data from only nodes each in state L without waiting for the completion of processing for reading out data from a node in state H, the processing being predicted to need a large amount of time until its completion because of high-load processing to be performed concurrently with the processing in the node in state H.

The data is divided into, for example, (m+n) blocks including n parity blocks and m data blocks, and each of the divided blocks is distributed to, and stored in, a corresponding one of a plurality of nodes (m and n being each a natural number). Further, when having acquired a complete set of m data blocks from the parity blocks and the data blocks, data targeted for reading can be rebuilt. Thus, when the number of remaining blocks stored in a certain node is smaller than or equal to n, the data targeted for reading can be rebuilt without waiting for the completion of reading out the remaining blocks stored in the certain node.

The above is the summary of the reading method according to this exemplary embodiment of the present invention.

According to the aforementioned method, it is possible to prevent overlapping of a beginning portion of writing or reading processing with high-load processing. That is, it is possible to prevent the occurrence of a performance degradation due to overlapping of a beginning portion of writing or reading processing with high-load processing included in maintenance processing. In addition, this overlapping occurs because it is difficult to predict a timing point at which the writing or reading processing based on a request from an upper-layer application begins, and thus, a resource allocation is not in time at the beginning portion of the writing or reading processing. As a result, therefore, a performance requirement at the beginning portion of the writing or reading processing is satisfied.

Further, when high-load processing resumes subsequent to the completion of writing or reading processing based on a request from an upper-layer application, a period when no resources are used can be brought to naught. Thus, the problem that intermittent writing or reading processing increases the period when no resources are used does not occur.

Moreover, differences in a performance degradation between a general distribution storage apparatus and the storage system according to this exemplary embodiment of the present invention will be described below.

A general distribution storage apparatus is intended to improve processing performance by including a plurality of nodes; dividing data targeted for reading or writing after giving redundancy to the data; and concurrently performing I/O processing (I/O being an abbreviation of input and output). Simultaneously therewith, a general distribution storage apparatus is also intended to improve a fault tolerance by allowing the plurality of nodes to share the data having been given redundancy.

Through employing such a configuration, a general distribution storage apparatus is provided with, not only a fault tolerance against any function loss caused by a malfunction of part of the nodes, but also a capability to deal with a performance degradation of part of the nodes due to a certain reason.

In contrast, the storage system according to this exemplary embodiment of the present invention is intended to deal with processing, such as maintenance processing, for which the occurrence of a performance degradation can be predicted because this performance degradation is caused by carrying out processing whose execution schedule is predetermined, as a more preferable object, rather than processing for which the prediction of the occurrence of a performance degradation is difficult because this performance degradation is caused by unpredictable and uncertain problems, such as a malfunction and an insufficient data allocation.

Accordingly, it is possible to make a configuration described below for suppressing the occurrence of a performance degradation of the entire system even during execution of maintenance processing by utilizing the above-described characteristics of the distributed storage apparatus and the characteristic of the maintenance processing.

(1) Through utilization of the configuration in which the distributed storage apparatus is constituted of a plurality of nodes, a node whose performance degradation is predicted is temporarily restricted to a partial node such that a time zone during which the maintenance processing is performed is made different mutually among the plurality of nodes.

(2) In a node whose performance degradation is predicted, since a degradation of response performance is predicted, it is avoided to apply such a synchronous writing method that guarantees the reliability of writing data. The guarantee of the reliability of writing data is maintained by causing each of remaining nodes currently not performing the maintenance processing to perform synchronous writing or the like with respect to the writing data. This is derived from a viewpoint of the present invention, in which it becomes possible to change the property of writing in advance by utilizing a characteristic in which the distributed storage apparatus performs division of data such that the data is given redundancy, and a characteristic in which it is possible to predict a node whose processing performance will be degraded.

(3) With respect to reading, similarly, data is rebuilt from pieces of data from nodes other than a node whose performance degradation is predicted. This also becomes possible from the redundancy of data and the prediction of a node whose processing performance will be degraded.

As described above, in this exemplary embodiment according to the present invention, when, in the distributed storage system provided with redundancy, there exists high-load processing, such as a maintenance task, which is periodically performed by each of all nodes, a node which performs the high-load processing is determined in advance. Moreover, a method for writing or reading processing based on a request from a user is changed in advance between the node which has been determined as a node which performs high-load processing and each of the other nodes. As a result, it is possible to satisfy a given performance requirement criterion with respect to each of writing processing and reading processing, and realize the improvement of an efficiency of the high-load processing.

Through employing the configuration and method having been described in this exemplary embodiment according to the present invention, it is possible to determine, in advance, the quality of writing and reading with respect to a high-load processing node as well as the quality of writing and reading with respect to each of the other nodes. Thus, the configuration and method of the storage system according to this exemplary embodiment of the present invention make it possible to, even in a distributed storage system in which there exists a high-load processing node, such as a node performing a maintenance task, prevent the occurrence of a performance degradation of the entire system, and satisfy a sever performance requirement.

### Modification Example

In this exemplary embodiment of the present invention, the configuration in which a data distribution is performed by a plurality of storage nodes has been described. Besides, a configuration in which a data distribution is performed by, not the plurality of nodes, but a plurality of disks inside a disk array apparatus can also bring about similar advantageous effects.

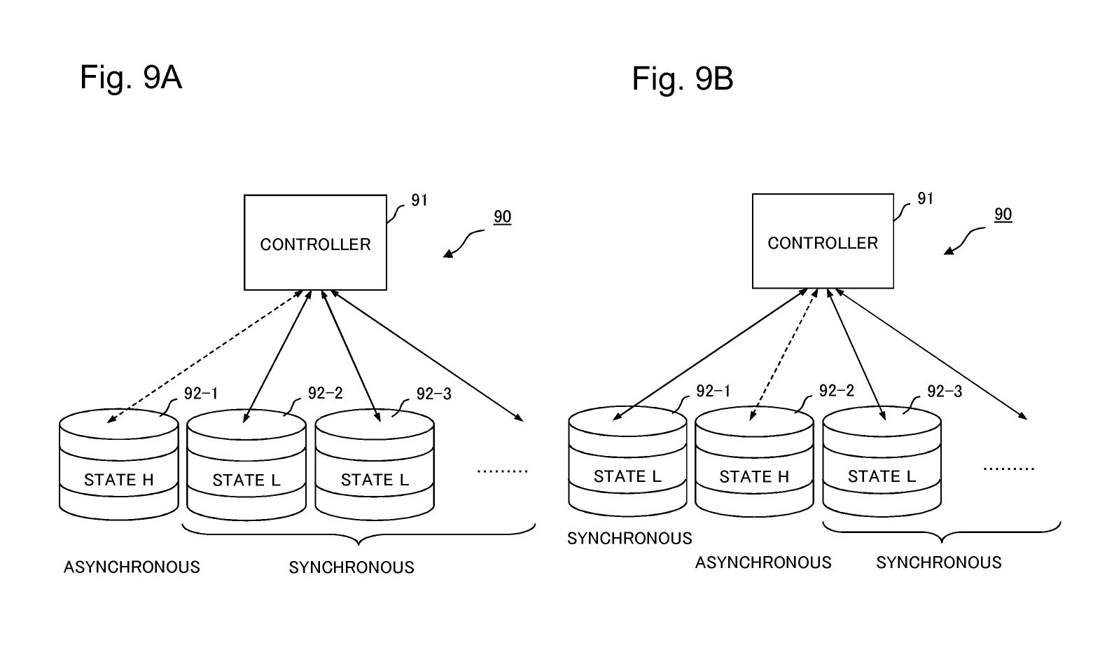

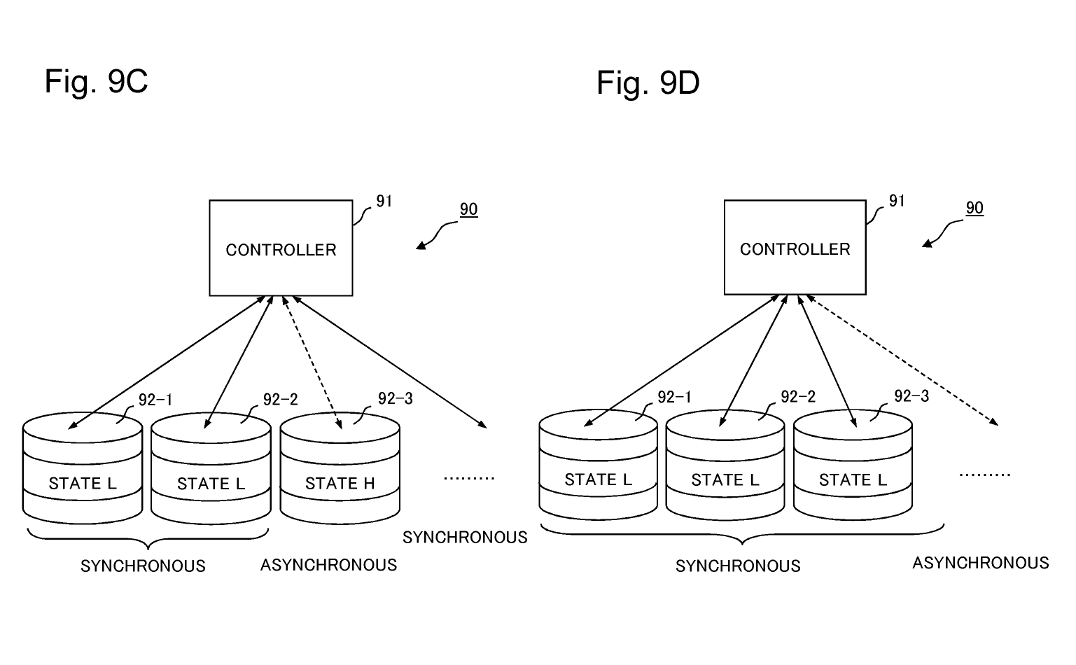

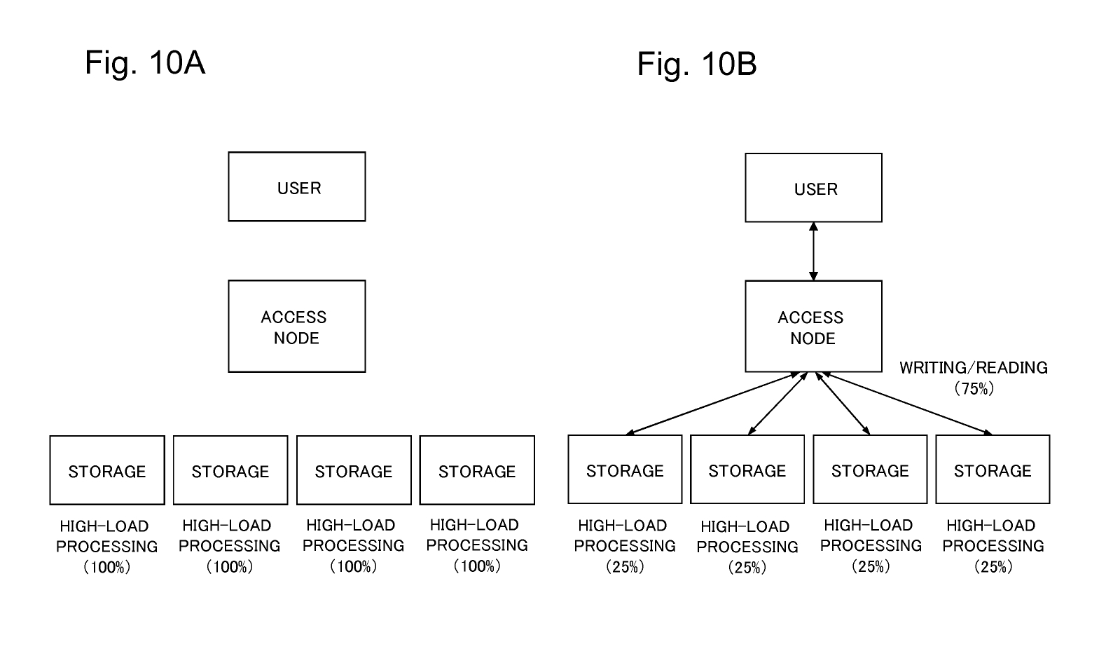

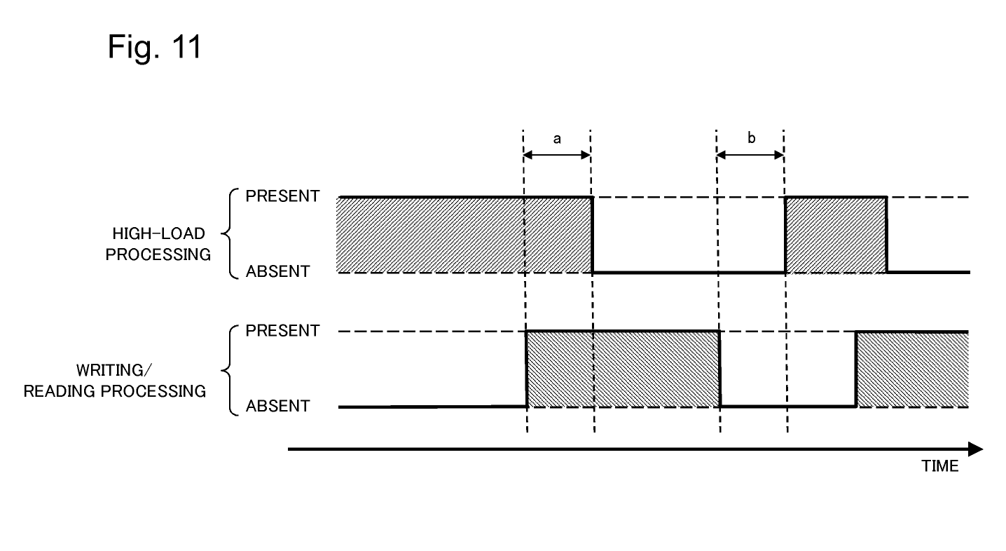

An example of this modification example according to the exemplary embodiment of the present invention is illustrated in FIGS. 9A to 9D. In FIGS. 9A to 9D, there is illustrated a disk array apparatus 90 in which a plurality of disks 92 (92-1, 92-2, 92-3, . . . ) is controlled by a controller 91. Further, in FIGS. 9A to 9D, with respect to line segments each having arrows at its opposite ends, and connecting between the controller 91 and each of the plurality of disks 92, a line segment denoted by a full line indicates “writing or reading processing that waits for its completion”, and a line segment denoted by a dashed line indicates “writing or reading processing that does not wait for its completion”.

The controller 91 has the same configuration and function as those of the access node 10 shown in FIG. 2, and further, has the same configuration and function as those of a storage node resulting from deleting the disk 28 from the storage node 20 shown in FIG. 2. The controller 91 performs control of writing and reading into/from the plurality of disks 92. That is, the disk array apparatus 90 is configured such that, in the configuration shown in FIG. 2, in addition to the access node 10, a single storage node 20 including the plurality of disks 92 shown in FIGS. 9A to 9D as substitution for the disk 28 is provided. In addition, the configuration and function of the storage node resulting from deletion of the disk 28 from the storage node 20 shown in FIG. 2 may be provided to each of the plurality of disks 92 shown in FIGS. 9A to 9D, or may be provided to all the plurality of disks 92 shown in FIGS. 9A to 9D as a configuration and function as a whole.

Further, each of the plurality of disks 92 may include a plurality of hard disks, or may include a single hard disk. Further, each of the disks 92 is not necessarily a hard disk, provided that a substitution for the disk 92 has a storage function, and an appropriate storage device can be employed as the substitution for the disk 92.

The plurality of disks 92 may be configured as, for example, RAID (this “RAID” being an abbreviation of redundant arrays of inexpensive disks or redundant arrays of independent disks). For example, one of the plurality of disks 92 may be a disk dedicated to parity blocks as RAID 4. Further, a parity block may be distributed to some ones of the plurality of disks 92 as a RAID level 5. Moreover, a plurality of parity blocks may be distributed to some ones the plurality of disks 92 as RAID 6. In addition, RAID levels are not be limited to the above RAID levels, and further, the plurality of disks 92 may not be configured as RAID.

In FIGS. 9A to 9D, there is illustrated a condition in which the disk array apparatus 90 performs access operation which is the same as the writing or reading operation of the storage node 20 shown in FIGS. 3A to 3D. In addition, in FIGS. 9A to 9D, there is illustrated a condition in which a node in state H makes a transition in order as follows: FIG. 9A; FIG. 9B; FIG. 9C; and FIG. 9D, but the order of the transition is not limited to the above order shown in FIGS. 9A to 9D.

In the state shown in FIG. 9A, a disk 92-1 is carrying out high-load processing, and thus, its state is stored as state H. When high-load processing in the storage node 92-1 in state H has been completed, a high-load management unit (not illustrated) of the controller 91, which has the same function as that of the high-load management unit 16 shown in FIG. 2, causes a next storage node 92-2 to carry out high-load processing, and updates a state stored in a high-load node storage unit (not illustrated), which corresponds to the high-load node storage unit 17 and the high-load node storage unit 27 which are shown in FIG. 2. That is, as shown in FIG. 9B, the state of the disk 92-2 and the state of the disk 92-1, which are shown in FIG. 9A, are changed into state H and state L, respectively.

Similarly, when the high-load processing in disk 92-2 has been completed, as shown in FIG. 9C, a disk 92-3 is changed into a disk carrying out high-load processing. Moreover, as shown in FIG. 9D, with respect to disks other than the disks 92-1 to 92-3, an operation which causes a disk 92 carrying out high-load processing to make a transition is repeated until the execution of the high-load processing has been completed in each of all the disks 92.

In addition, the transition with respect to the states shown in FIGS. 9A to 9D may be made in units of a plurality of disks 92, or may be made in a unit of a hard disk constituting every plurality of disks 92.

The above is description of an example of the modification example. It is to be noted here that the aforementioned description of the modification example is just an example, and configurations resulting from making various modifications and/or additions thereon are also included in the scope of the present invention.

### REFERENCE SIGNS LIST

1: A storage system
10: An access node
11: External access unit
12: Data division unit
13: Data distribution unit
14: Writing method control unit
15: Writing transfer unit
16: High-load management unit
17: High-load node storage unit
18: Reading unit
19: Data uniting unit
20: A storage node
21: Writing and reading processing unit
22: Hash entry registration unit
23: Data verification unit
24: Hash entry transfer unit
25: Hash entry collation unit
26: Hash entry deletion unit
27: High-load node storage unit
28: Disk
30: Bus
40: Data writing and reading means
90: Disk array apparatus
91: Controller
92: Disk

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

1. A storage system comprising:
a plurality of storage nodes in which data is stored in a distributed way, and
wherein, when high-load processing is carried out by each of at least one of the plurality of storage nodes,
in each of the at least one storage node carrying out the high-load processing, an access is made in a method in which the access is made asynchronously with an access by each of at least one storage node other than the at least one storage node carrying out the high-load processing among the plurality of storage nodes, and a completion of the access is not waited for, and
in each of the at least one storage node other than the at least one storage node carrying out the high-load processing among the plurality of storage nodes, an access is made in a method in which the access is made synchronously with any other one of the at least one storage node other than the at least one storage node carrying out the high-load processing among the plurality of storage nodes, and a completion of the access is waited for.

2. The storage system according to claim 1, wherein one of the at least one storage node other than the at least one storage node carrying out the high-load processing among the plurality of storage nodes stores therein a replica of data which is written into each of the at least one storage node carrying out the high-load processing.

3. The storage system according to claim 1, wherein each of the at least one storage node carrying out the high-load processing stores therein a hash value corresponding to data which is written into the each of the at least one storage node carrying out the high-load processing, and one of the at least one storage node other than the at least one storage node carrying out the high-load processing among the plurality of storage nodes stores therein a replica of the data which is written into one of the at least one storage node carrying the high-load processing, as well as a hash value corresponding to the data which is written into one of the at least one storage node carrying out the high-load processing.

4. The storage system according to any one of claim 1, further comprising an access node which is data communicably connected to each of the plurality of storage nodes,
wherein the access node includes external access means that deals with a request for reading data and a request for writing data from an external object, and transfers the data; data division means that divides the data transferred from the external access means into a plurality of blocks including a data block and a parity block; data distribution means that determines one of the storage nodes as a distribution destination of a corresponding one of the blocks divided by the data division means; writing transfer means that, in accordance with the determination made by the data distribution means, transfers the corresponding block to the storage node which is a distribution destination of the corresponding block; high-load node management means that manages the at least one storage node carrying out the high-load processing; first high-load node storage means that stores therein the at least one storage node carrying out the high-load processing; and writing method control means that refers to the first high-load node storage means, and in accordance with the presence or absence of the at least one storage node carrying out the high-load processing, performs control of a writing method for each of the blocks, and
wherein the data received by the external access means is divided into the blocks, and each of blocks to be written into the at least one storage node carrying out the high-load processing among the blocks is stored, as the parity block, into one of the at least one storage node other than the at least one storage node carrying out the high-load processing among the plurality of storage nodes.

5. The storage system according to claim 4,
wherein the access node includes reading means that collects the plurality of blocks from the storage nodes, and data uniting means that rebuilds the data from the blocks collected by the reading means, and
wherein the reading means transfers the collected blocks constituting the data to the data uniting means; the data uniting means transfers the rebuilt data to the external access means; and the external means transmits the rebuilt data, which is rebuilt by the data uniting means, to the external object.

6. The storage system according to claim 4,
wherein each of the storage nodes includes block storage means that stores therein a plurality of the corresponding blocks transferred to the each of the storage nodes; writing and reading processing means that makes an access to the block storage means in response to an access request received from the access node; hash entry registration means that creates a plurality of hash entries each associated with a corresponding one of the plurality of corresponding blocks, and registers the plurality of hash entries into a hash table; hash entry transfer means that transfers part of the plurality of hash entries having been registered by the hash entry means to the at least one storage node carrying out the high-load processing; hash entry collating means that collates each of a plurality of hash entries, which are transferred from the at least one storage node other than the at least one node carrying out the high-load processing among the plurality of the storage nodes, and which include the part of the plurality of hash entries transferred by the hash entry transfer means included in one of the at least one storage node other than the at least one node carrying out the high-load processing among the plurality of the storage nodes, with a corresponding one of the plurality of hash entries owned by the each of the storage nodes itself; hash entry deletion means that deletes the hash entries for which the accordance has been verified by the hash entry collating means; data verification means that causes the hash entry transfer means, the hash entry collating means and the hash entry deletion means to operate in order to verify accordance with respect to the plurality of the corresponding blocks after a completion of writing of the plurality of the corresponding block; and second high-load node storage means that stores therein information which is related to the at least one storage node carrying out the high-load processing, and which is acquired from the high-load node management means included in the access node.

7. The storage system according to claim 6, wherein the data verification means included in each of the at least one storage node carrying out the high-load processing causes the hash entry transfer means to collect the plurality of hash entries related to the each of the at least one storage node carrying out the high-load processing from the at least one storage node other than the at least one storage node carrying out the high-load processing among the plurality of storage nodes; causes the hash entry collating means to collate each of the plurality of hash entries collected from the at least one storage node other than the at least one storage node carrying out the high-load processing among the plurality of storage nodes with a corresponding one of the plurality of the hash entries owned by the each of the at least one storage node carrying out the high-load processing; in the case where the hash entry collating means has determined that there is accordance with respect to the hash entries having been collated thereby, causes the hash entry deletion means to delete the plurality of the hash entries which exist in all the storage nodes and which are related to the plurality of corresponding blocks targeted for the verification; and in the case where the hash entry collating means has determined that there is no accordance with respect to the hash entries having been collated thereby, causes the hash entry deletion means to, after having caused the hash entry transfer means to acquire the plurality of corresponding blocks which are related the plurality of hash entries for which it has been determined that there is no accordance, delete the plurality of hash entries which exist in all the storage nodes and which are related to the plurality of corresponding blocks targeted for the verification.

8. The storage system according to any one of claim 1, wherein the high-load processing is sequentially carried out by each of the at least one node among the plurality of nodes such that, when, in one of the at least one node carrying out the high-load processing, the high-load processing has been completed, the one of the at least one node carrying out the high-load processing is replaced with one of the at least one node other than the at least one node carrying out the high-load processing among the plurality of nodes.

9. A disk array apparatus comprising:
a plurality of disks in which data is stored in a distributed way,
wherein, when high-load processing is carried out by each of at least one of the plurality of disks,
in each of the at least one disk carrying out the high-load processing, an access is made in a method in which the access is made asynchronously with an access by each of at least one disk other than the at least one disk carrying out the high-load processing among the plurality of disks, and a completion of the access is not waited for, and
in each of the at least one disk other than the at least one disk carrying out the high-load processing among the plurality of disks, an access is made in a method in which the access is made synchronously with any other one of the at least one disk other than the at least one disk carrying out the high-load processing among the plurality of disks, and a completion of the access is waited for.

10. A control method for a storage system including a plurality of storage nodes in which data is stored in a distributed way, the control method comprising:
when high-load processing is carried out in each of at least one of the plurality of nodes;
in each of the at least one storage node carrying out the high-load processing, making an access in a method in which the access is made asynchronously with an access by each of at least one storage node other than the at least one storage node carrying out the high-load processing among the plurality of storage nodes, and a completion of the access is not waited for; and
in each of the at least one storage node other than the at least one storage node carrying out the high-load processing among the plurality of storage nodes, making an access in a method in which the access is made synchronously with any other one of the at least one storage node other than the at least one storage node carrying out the high-load processing among the plurality of storage nodes, and a completion of the access is waited for.
